(19) United States
(12) Patent Application Publication
(10) Pub. No.: US 2005/0193335 A1
(43) Pub. Date: Sep. 1, 2005

(54) Method and system for personalized content conditioning

(75) Inventors: Chitra Dorai, Chappaqua, NY (US); Edith H. Stern, Yorktown Heights, NY (US)

Correspondence Address: Douglas W. Cameron;IBM Corporation, P.O. Box 218, Yorktown Heights, NY, 10598, US

(73) Assignee: International Business Machines Corporation, Armonk, NY (US)

(21) Appl. No.: 11/119,442

(22) Filed: Apr. 29, 2005

Related U.S. Application Data
(63) Continuation-in-part of application No. 09/887,739, filed on Jun. 22, 2001.

(51) Int. Cl. G06F 17/00; G06F 3/00

(52) U.S. Cl. 715/530; 715/513; 715/500.1; 715/745; 707/102

(57) ABSTRACT

The present system and method provide an automated approach to conditioning of content. The content is scanned for topics for conditioning, then supplemental content is identified and selected using search tools such as general search engines searching the Internet and search tools for private databases. The conditioned content may be customized for a particular user or category of users, including different materials for different users, in different formats including multimedia, based on a profile for the user(s) for which the personalized content is being prepared. The topics for conditioning may be identified using a text analysis engine, either alone or in combination with a rules engine, in the preferred embodiment.

### CROSS REFERENCE TO RELATED PATENT

The present invention is a continuation-in-part application of a prior filed and copending patent application entitled “Method and System for Providing Web Links”, Ser. No. 09/887,739 filed Jun. 22, 2001 by David Singer et al., a patent application which is sometimes called the “Hot Link Creator Patent” in this document. This text and drawings of this Hot Link Creator Patent are hereby specifically incorporated herein by reference.

### FIELD OF THE INVENTION

The present invention relates to methods of conditioning content for instructional and other uses. More specifically, the present invention relates to methods for providing augmented materials including, but not limited to, video, audio, animation and graphics for editors or for end users, intended often, but not always, to accompany materials prepared in an educational or instructional setting.

### BACKGROUND OF THE INVENTION

In certain situations it is desirable to work from previously-prepared materials which are supplemented with appropriate new materials. This might exist in a classroom setting where previously-prepared materials are available on a particular subject and the presenter wishes to augment the materials (add to or change them) with more recent materials on related topics or different materials or from a different perspective. One way to augment the materials uses an author or an editor to consider what additional materials are available and which are most appropriate for use.

Authors and editors are expensive resources, however. When content is created for instruction, or for other purposes such as presenting news, it is often as difficult to find and prepare supplementary material as to prepare the original material. Further, it is difficult to keep the supplementary material current. Current events and facts, new concepts, new technologies can supersede or augment older material, but today must be laboriously added to the content mix in the current environment, using somebody who provides the editing or authoring function.

Many authoring system vendors have embraced various techniques and standards to produce learning content, but one significant problem with such systems is one of keeping the content current. This keeping content current often requires addressing the following issue: much of the content created today maintains the structure imposed on it by the tools used to create it, such as word processors, video cameras, database report generators or presentation software. These materials encompass structured documents such as text, and XML documents and unstructured content such as audio and video. As new content gets created, it becomes necessary to understand what the content references and to describe the subjects using metadata, so that appropriate supplemental content can get selected based on metadata to augment old instructional material.

A serious challenge with tagging content is the labor involved in the task. It is not operationally feasible to manually fill in a set of metadata tags for each item in a collection of materials, especially when the collection becomes large. Automated techniques have been proposed to analyze data such as text video, and graphics, to determine their structure and semantics and generate metadata descriptions recovered or inferred from this content.

The Hot Link Creator Patent addresses a related, though somewhat different, problem of finding and selecting related information and including a reference to that related information (a hot link) within the text so that a user can click on the hot link and find additional relevant information about the subject. This inclusion of hotlinks differs from the present invention, where related supplemental or auxiliary content is actually incorporated with the base material to form a single supplemented unit with enhanced or conditioned content. Also, in the current invention, the supplementary material may be indirectly related, while the hot links customarily point to materials that are directly related.

Structured Information Analysis

Instructional text modules, such as course material or tutorials, can often be viewed as composed of a number of main topics with interspersed subtopics. Text analysis systems segment a large body of text into shorter units by identifying topic shifts—those places in text where one subtopic ends and another begins—and partition the text at those identified boundaries. For example, IBM has developed text segmentation tools that automatically identify topic shifts based upon the idea of lexical cohesion, in particular the pattern of repetition of terms across pairs of sentences in a text. In addition, cue phrases (e.g., “However”) as well as document structure elements (e.g., a new paragraph) are used to determine topic shifts. There also exist algorithms that can analyze the XML Document Object Model (DOM) to parse the hierarchical structure of the document and identify candidate text segments by the hierarchical structure provided by various XML tags, such as headings. Further segmentation often can be performed using text segmentation module of the TALENT system, for example. Mary Neff, Roy Byrd and Branimir Boguraev, The Talent System: TEXTRACT Architecture and Data Model. Presented at SEALTS 2003—The Software Engineering and Architecture of Language Technology Systems Workshop at NAACL 2003. Expanded version submitted for publication in Natural Language Engineering

After segmentation, further descriptive metadata fields such as title, language, keywords, description, taxonomy can be determined using text analytics and statistical methods. Titles, keywords, summaries can provide succinct labels for a document when it is displayed in a catalog, a listing of search results, a textual or hyperlinked reference, a table of contents or course outline. Text analysis tools developed at IBM go beyond corpus-based keyword analysis, by first performing feature extraction to recognize significant vocabulary within the text, such as names of people, organizations, and places; multi-word terminology and abbreviations. They also determine the important statistical properties of summaries, by ranking sentences in a document according to their relevance, based upon the vocabulary recognized during feature extraction. The summaries will provide descriptions that are used to help users determine whether some learning content is appropriate and relevant.

Unstructured Information Analysis

Unlike text, some media such as classroom lecture videos and training video modules and news broadcasts do not have explicit structural markers to partition them into smaller units. They also depict a variety of content. The videos can contain audio (including speech, music, background sounds), presentation material such as slides and other visual content such as images containing graphical text, demonstrations in the form of animations and video clips within the videos. Some automated techniques have been proposed that use audio, video, and graphical text processing to decompose a video into a hierarchy of inter-related structural units that can effectively serve as the table of contents for the video. Once the video is segmented into cohesive units, metadata such as title, keywords, and description for each unit can be derived automatically from analysis of text associated with these units as spoken words, as closed caption, or as embedded text within video frames of the units. For example, techniques to examine the narrative structure in terms of the instructor's delivery of the content (referred to as narration), Q&A session, classroom discussion, background music, etc leading to an automated segmentation of the video into units that can be described succinctly are well-established. There is also other published work on partitioning the video using its visual structure into text frames, web pages, demos, slides, etc. Ying Li and C. Dorai, “Detecting discussion scenes in instructional videos”, International Conference on Multimedia & Expo (ICME '04), June 2004. Ying Li and C. Dorai, “SVM-based audio classification for instructional video analysis”, International Conference on Acoustics, Speech and Signal Processing (ICASSP '04), May 2004.

Content Authoring Systems

Content authoring systems and tools such as Knowledge Producer, Adobe Writer, and Microsoft's PowerPoint aid in preparing electronic documents of instructional content as course modules, text, and presentations. While many of these allow embedded URLs of web sites that may contain additional content, there is no easy mechanism to make all sorts of regular content to be automatically updateable and keeping them current without turning them all into URLs or URIs that take users outside the document they are viewing. U.S. Pat. No. 6,370,551 provides a Method and apparatus for displaying references to a user's document browsing history within the context of a new document, and teaches a method of enhancing content by referring to content contained in previously read documents. This patent teaches how materials read may be annotated and stored, so that when similar materials are viewed (as determined by the materials exceeding a similarity threshold), the previously read materials are indicated via selectable links. The user can then choose to follow the links and connect the new material with material in previously read documents. This technique can increase comprehension by drawing connections with previously learned material.

Content Conditioning

The term “content conditioning” (and the related term “conditioned content”) may mean different things to different people in different industries. As the term is used herein, it refers to a process of enhancing original content such that the original content is presented and augmented with relevant material from other sources, where the relevant material from other sources is selected based on the intended recipient or consumer of the content. The augmented material may be selected based on freshness, demographic information, a consumer profile, personalization algorithm or some combination of these and other relevant factors. The original content is not altered but it is conditioned by supplementing it with additional materials, thereby creating a new entity—conditioned content that has more value that the original.

Content conditioning typically involves preparing content for entry into a content management system including assigning keywords to facilitate categorization, search and personalization. In video broadcasts, content conditioning typically occurs prior to encoding to provide content at the highest fidelity possible. In all of these cases, content conditioning is used in some sense to optimize the content itself for either storage or delivery. Examples are found in products and solutions from companies such as Sonic Foundry (www.panamsat.com) and Thomson (www.thomson.net). Existing methods of content conditioning deal with delivery and search.

E-Books, and Print on Demand

Many informational or educational materials are available electronically and on demand. E-books, or electronic books, may be previously published in paper or may be created for the electronic market. Print on demand publishers fill the need of creating paper copies of books from electronic forms on the demand of a purchaser. A purchaser selects a book from a list or catalogue and a paper copy is printed and made available. These two techniques are used to make available in one form or another static materials. That is, two successive accesses produce the same information.

Personalization

Personalization is the process of providing materials or services based, at least in part, on individual users' characteristics or preferences. It can be used to increase user satisfaction, enhance customer service or sales. There are a number of personalization products available to tailor web pages, and portals. Many software applications allow a user profile to be used to tailor some aspect of the interface or templates associated with the application. Personalization for effective marketing may be accomplished through collaborative filtering. In this technique a filter is applied to information from different sources to determine what data is relevant to a specific customer. Affinity groups (e.g. “many people who buy this first book also bought this second book”) can also be used to help pre-select items of interest.

Limitations and Disadvantage of the Prior Art Systems

What is desired is a way to create material for instruction, news reporting and/or other purposes that incorporates original material with supplementary content, without need for extensive editor or writer resources. A way to leverage evolving analysis techniques for unstructured information is needed to provide more relevant supplementary materials and to select from those materials the ones which are most relevant to the particular user being served (sometimes also called the recipient). Such techniques include natural language techniques, text analytics, and personalization. A way is desired to provide final copy, or a draft copy of materials, including both original materials and supplementary materials. What is needed is a way to include not only supplemental materials in text form, but also video, audio, animation and graphic contents, in an appropriate situation (where the medium allows for such other non-text materials to be employed to advantage). The ability for content to drive personalized online education, news presentations and other content delivery depends directly on how richly the content can be characterized by metadata and supplemental information delivered to inform and instruct the application. Further, instruction, education and news processing is more effective when it is enriched with auxiliary learning materials that explain and amplify the lesson and/or the news. The more intelligence an application has about content, the more effectively it can deliver the right content to the right user at the right time. Today, content conditioning operates solely on the content itself and does not extend the content and does not personalize it for the particular intended recipient. Extensions are typically manually created, in a painstaking and time intensive manner, which is, of course, a costly process. What is desired is a way to condition content so as to extend and enrich it, without need for laborious creation activities. As students learn, the presentation of examples and illustrations can greatly enhance the learning experience and reduce the time necessary to learn. Web searches can allow a student to seek new information, but have the disadvantage of requiring skill to perform, and resulting in information of variable quality. Currently, prepared materials have the disadvantage of static information—that is, they always show the same information without regards to current events or changes. What is desired in connection with the present invention is a method of providing fresh insights into the material so that a student may have different views with each successive revisiting of the topic.

From the foregoing discussion of the past activities in this field, it will be understood and appreciated by those skilled in the relevant art that the authoring and content conditioning systems present in the current prior art have significant disadvantages and undesirable limitations.

### SUMMARY OF THE INVENTION

The present invention overcomes the disadvantages and undesirable limitations of the prior art systems and provides an improved method and system for automatically conditioning content with appropriate supplemental material, personalized to a set of objectives stored for the particular intended user(s) of the material. In this way, the present system and method create personalized content with supplemental material that has been selected based on the intended audience, and the same base material may provide different output based on the stored preferences related to the intended user. That is, the output for a single base content conditioned through the use of the present invention may be quite different depending on those stored preferences, even using the same source for supplemental material, a situation which is eminently reasonable upon reflection, because the audience may be quite different and the objectives for conditioning may vary substantially from one conditioning to the next. This difference in conditioned content may become even more understandable, since the stored user preferences may indicate that the one intended user is a third grader interested in geographic information related to a subject such as a country and another intended user is a college student interested in recent political events related to the country under consideration. Under these different circumstances, one would actually expect the conditioned content to be different, first in reading level and second in emphasis.

The present invention thus allows using a set of stored requirements for an intended user to personalize (or customize) the conditioned content for that intended user. Two users with the same starting content and different criteria for selecting related content thus could get significantly different content, even with the same databases and pool of augmenting information from which the conditioned content is derived, even operating at substantially the same time.

Of course, operating with different databases and at different times is also possible, and, depending on the criteria selected for the user's preferences, may generate similar or different results. For example, if a user asks for the most recent content on a particular subject, it is likely that the content will have been augmented and more recent information be available if the user conditions the same content at a substantially later time. However, if the user has selected time-insensitive parameters (like historical information or oldest materials or a particular reading level), it is possible that the conditioned content would not change significantly over a long period of time.

The present invention has the advantage of removing some of the labor required in finding and preparing supplemental materials to accompanying content, such as instructional materials.

The present invention has the additional advantage that the user gets content which may be specifically conditioned for him—at a particular reading level, a particular slant on the material or in a particular language.

One further advantage of the present invention is that the labor effort of editors in finding and selecting content is reduced and the variety of types of content that may be conditioned is increased as a result of the present invention.

Other objects and advantages of the present invention will be apparent to those skilled in the relevant art in view of the following detailed description of the preferred embodiment taken together with the accompanying drawings.

### BRIEF DESCRIPTION OF THE DRAWINGS

FIG. 1 is a block diagram illustrating a content creation system of the prior art;

FIG. 2 is a block diagram illustrating a revised content creation system, which uses aspects of the present invention;

FIG. 3 is a flow diagram illustrating a method of content conditioning, according to an embodiment of the present invention;

FIG. 4 shows an example of base content that may be used to depict the workings of the present invention;

FIG. 5 shows the augmented content using the base content of FIG. 4 and augmented content created using the present invention;

FIG. 6 shows conditioned material from the use of the base content of FIG. 4 and the augmented or supplemental content of FIG. 5 using the present invention;

FIG. 7 shows detail of an illustrative process for supplemental material selection that may be useful in the present invention; and

FIGS. 8a and 8b show two examples of user preferences, the detail of the criteria that may be used to select the content conditioning information using the present invention for a particular user or category of user.

### DETAILED DESCRIPTION OF PREFERRED EMBODIMENTS

Our invention includes a method and system for using natural language techniques, analytics, and etc. to extend content based on preferences associated with a user or an intended audience. This can be used as an aid for the content creator in constructing the materials, including base materials and personalized supplementary materials. In a preferred embodiment, this can further be personalized to the student with an individual set of materials.

In our invention, once the base material is created or identified, the inventive system analyzes the base material to determine important or significant elements within the base material. This can best be understood by the following example: if the material is an essay on current events in United States politics, the most important elements may be determined to be 1) political candidates currently involved in a campaign election for office, 2) a legislative bill under discussion and 3) a scandal. In our invention, a subset of these elements is selected for augmentation (e.g. candidates, scandal). For each of these two, the inventive system then determines additional material of possible relevance or interest. In our example, this may include a short biography of the candidates, a history of selected scandals in United States politics, a biography of one of the candidates, or other relevant information. These selected materials may come from the web, a public or private database, a library, or other available sources.

Optionally, if the invention is being used to personalize educational, news and/or other base materials, the system may at this point compare the supplementary materials selected against the materials previously viewed by the student and use only new materials (or only the materials which had previously been presented, a feature which is useful for a review of the subject). If this is the second time through the content for a particular user, this selection of new materials allows the supplementary materials to be dynamically updated. Further, the system may at this point examine the material and grade it as appropriate for the student based on language, level of discourse, difficulty or other measures. In our example, for a grade school student, supplementary materials on scandals may be excluded on this basis, as could an article written at a twelfth grade educational level. The system then would include such materials for presentation to an educator or to a more-advanced student.

Note that current learning standards such as SCORM (www.adlnet.org) provide content metadata that describe pedagogical characteristics of the content in terms of difficulty level, typical age range, typical learning time, etc. Any such metadata can be exploited to drive the content conditioning process we describe.

The format for the output of the conditioned content must be considered in the preparation of the conditioned content. If the output is an audio visual work with a combination of pictures, sounds and words, then the supplementing materials may be in any format which the output can accept. Further, the output may be in a linear arrangement in which one piece of content follows another like a movie, or it may be arranged in parallel or branching arrangements, and the base material and the supplemental material can be arranged in any format which the output format will accommodate. On the other hand, if the format or the arrangements are limited (if, for instance, the output is a printed report), then the materials selected for the supplementing must be in that format (and it would do no good to locate a related audio segment if the output has no audio).

We now provide a detailed description of the Figures that accompany this textual description of the preferred embodiment of the present invention to illustrate the concepts of the present invention to those of ordinary skill in the relevant art. Of course, many variations are possible without departing from the spirit of the present invention, and it is possible to derive many advantages of the present invention from some of the features described without the corresponding use of other features:

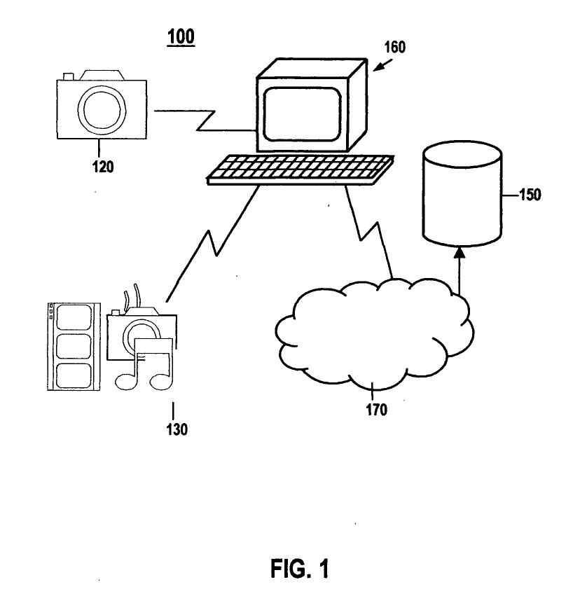

FIG. 1 illustrates and describes a content creation system as used today, that is, a prior art system for content creation.

FIG. 1 shows a current system 100 for content creation system. This system 100 includes content capture, aggregation, transmission, and storage. In FIG. 1, 160 is the client device, such as a desktop computer that is used to create text content using some word processing software. Additional devices 120, 130 are cameras and camcorders that can be used for image or video capture, creating content which can be integrated into the text document and be prepared as a rich multimedia document. The desktop is connected via a network 170 to transmit the created document to a remote server, 150 with attached storage. The network 170 may be an Ethernet LAN or WAN connection, GPRS network, a 3G network, or a network permitting access by other wireless means. It is anticipated that multiprotocol devices will soon be available for example, allowing wireless connectivity through several different protocols, such as 802.11b. The protocol for transmission of the created document can be conventional e-mail, and is well known in the art.

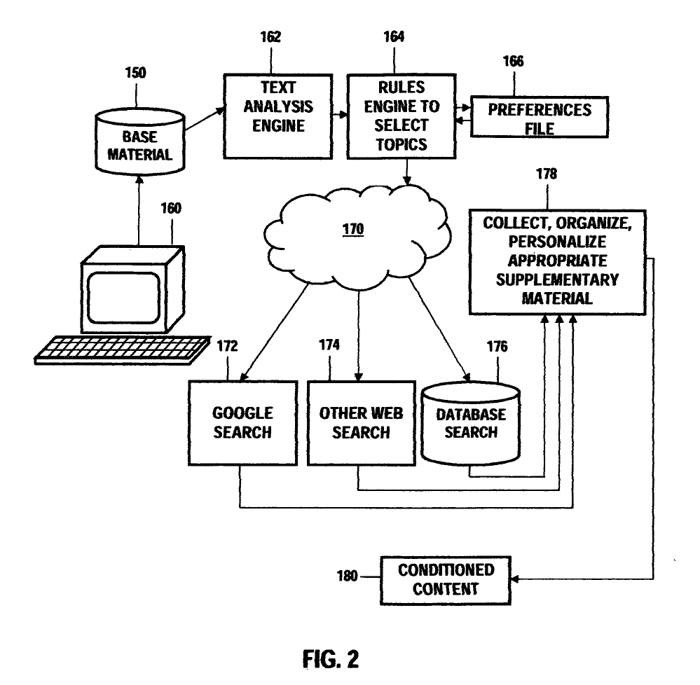

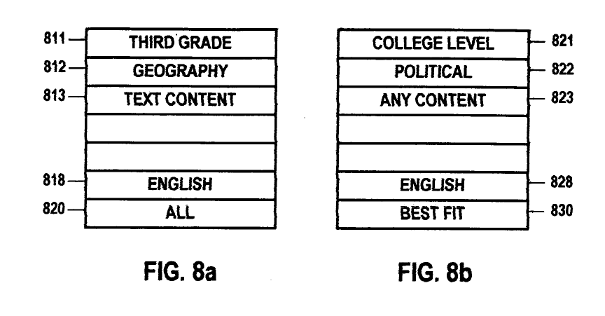

FIG. 2 describes a content creation system according to the present invention, where base material 150 is used to guide search across private and public databases, search on the Web and other paid information services using key words that can serve to determine topics, which have been extracted by applying a text analysis engine 162 to the base material or content 150, preferably in an automatic or semi-automatic mode and based upon user preferences 166. Additionally a rules engine 164 can be used to select topics from the key words so that different degrees of importance, relevance, and context appropriateness can be attached to different topics, preferably based on the preferences file 166. The contents and operation of the preferences file 166 shown in this figure will be explained in greater detail later, particularly in connection with FIGS. 8a and 8b, but allow for the preferences to be considered for the intended user and allow for different preference files to be employed for different users to create a customized or personalized output based on the same base material. As discussed elsewhere, these preferences could be a comprehension or reading level, a set of interests or specific subjects, a preferred language or other criteria, in some combination. The search for supplementary material is conducted using the Google search 172, or at other web sites and portals 174, or in private and public databases 176. Search results from various information sources are collected, organized and selected according to preferences such as media format, date of publication, and personalized using preferences in 166 to augment the base material, producing conditioned content 180.

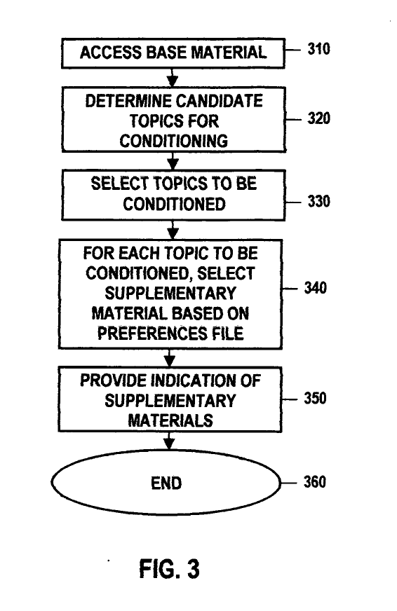

FIG. 3 describes an aspect of the inventive content conditioning method and system of the present invention. This method begins with step 310 where we access the base material. This material may be newly created, and available for access through a creation or editing application, or may have been previously created. Access may be obtained through reading a file, accessing at least one record in a database, receiving data through a communications network, wired or wireless.

In step 320 we determine candidate topics for conditioning. Such topics may be determined through a variety of analysis techniques. Those skilled in the art will recognize that a number of techniques are available for text or content analysis including, but not limited to, text analysis, language identification, keyword extraction, major topic determination and analysis of audio and/or video content. Such analysis may be based on frequency or duration of a topic, or the position of the material (for example, in the title or a topic sentence). Further, in addition to potential candidate topics revealed through analysis of the text, additional potential candidates can be obtained through keyword lists, subject lists, data base matches, class syllabus or objectives, student histories, skills objectives and so on. Once candidate topics have been determined at the step 320, the present method proceeds to step 330 of actually selecting topics to be conditioned. Note that in a preferred embodiment, these steps may be performed iteratively. That is, on identification as a potential candidate, the method may proceed to determination of suitability (e.g., application of selection criteria) for each potential candidate topic in turn. A final evaluation step may be used to sort the most significant candidate topics.

In step 330, we select which topics are to be conditioned. Selection may be accomplished by applying criteria associated with topic suitability for the intended audience, by criteria for freshness of new information (e.g., availability and/or quantity of recent supplementary material), by criteria for importance in relation to educational objectives, by comparison to history of previous topics selected, by preference profile of the material creator or editor, preference profile of the intended recipient(s), by cost, by price, by contract with the provider of the materials, by policy (e.g., a policy to include equal amounts of science and social science supplementary material), by importance in the base material, by difficulty level of supplemental material, by availability of supplemental material or availability of expertise in the supplemental material.

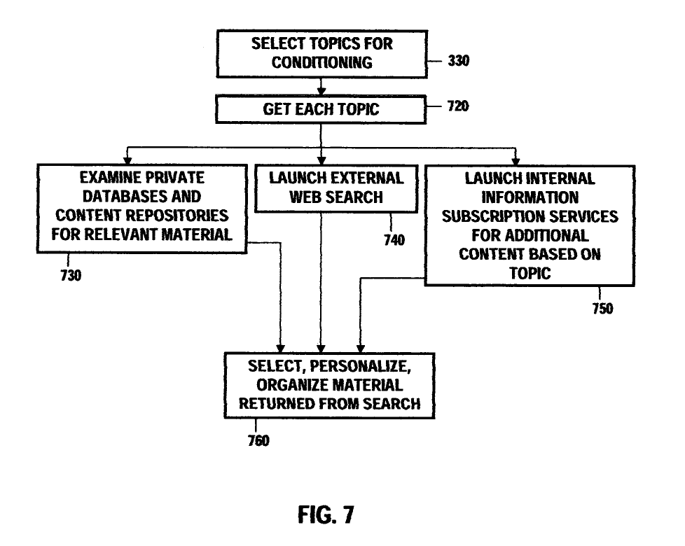

The present method then continues to step 340. In step 340 where supplemental material is selected based on the preferences file and the identification of topics being conditioned. This supplemental material may be obtained via a network, wired or wireless, via solicitation from a content provider such solicitation including a query, a request, a search, via web search of authorized web sites, from a database of stored materials, from a file of stored materials, etc. In a preferred embodiment, the supplemental material may be prioritized or organized for suitability based on number of candidate topics to which it is relevant, quality, age appropriateness, size of material, freshness, preference profile of the material creator, cost, contract associated with the provider, policy, importance, relevance, metadata associated with the materials, attributes associated with the materials. A detailed description of one implementation of step 340 may be found depicted in FIG. 7 and described in conjunction with that depiction.

We continue to step 350. In step 350, the method of the present invention provides an indication of at least some of the supplementary materials. Such indication may include but is not limited to pointers, URLs, electronic copies of the materials, tentatively formatted copies of the materials in conjunction with the base material, selection lists incorporating titles or descriptions of the materials. In a preferred embodiment, a further manual selection step of at least one item of supplementary materials is used to influence a further iteration of the selection process for either topic or supplementary material. In our example above, once a candidate biography is selected, the inventive method may exclude legislative biographies from the supplementary material under consideration. Of course, the indication of the conditioned content could also be to form the conditioned content, that is, the base content with the appropriate supplementary content to form a customized conditioned content item. Once the indication of supplementary materials has been made, the method is complete.

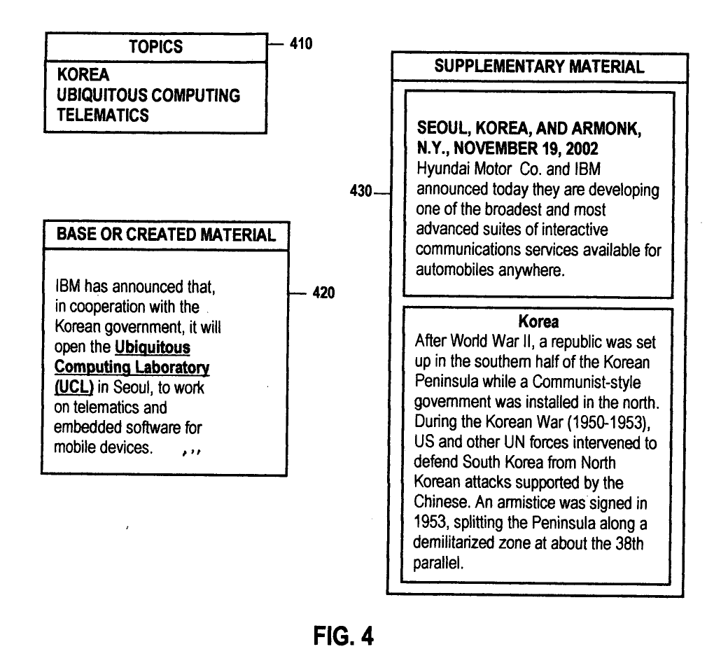

FIG. 4 shows an example of data elements of the invention. Element 420 is base material, in this case concerning an announcement of the creation of a laboratory in Korea. Element 410 shows topics extracted via text analysis from the base materials. Elements 430 show examples of supplementary material available that is associated with at least one of the topics.

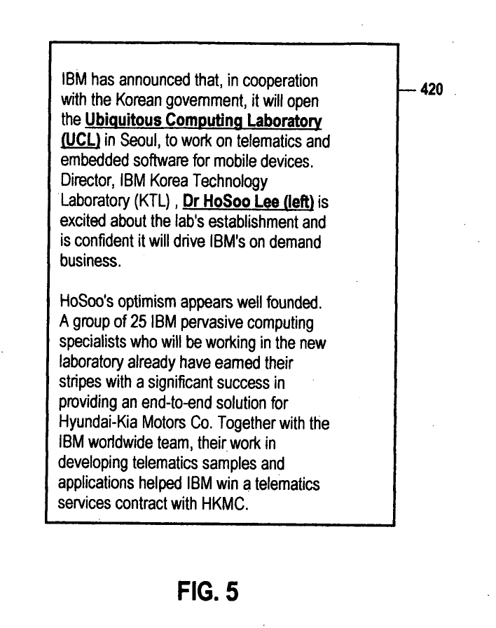

FIG. 5 shows the base material 420 for the illustrative content conditioning exercise discussed herein. This FIG. 5 shows the full text of the base material to be incorporated in the final edited format, without any supplemental material.

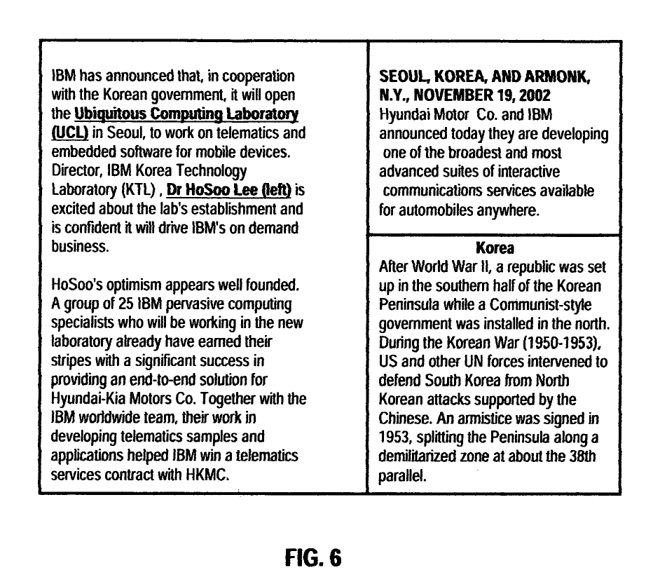

FIG. 6 shows conditioned material, that is, the base material 420 with the supplementary materials 430. In this FIG. 6, the base material 420 and supplemental materials 430 which have been selected are formatted together in a single view. In a preferred embodiment, the editor may access material previews that show the effect of various combinations of supplemental material formatted with the base material in a single view.

FIG. 7 shows detail of obtaining supplemental material. Once topics are selected for conditioning (at the step 330), the process begins with step 720. For each topic selected, we first examine private repositories for relevant material. Such private repositories may include corporate databases, analyst reports, corporate intranets and the like. Materials may be ranked as to relevance based on metadata, such as date or origin, author, unit of origin and the like. Materials may be ranked as to relevance based on text analysis of the material or other well-known technique. We proceed to step 740 where we launch an external web search Such search may use one or more generally-available public search engines such as Google, or employ services that provide federated search capability such as IBM's Web Fountain. In step 750 we launch a search with an internal subscription service for content based on this topic; that is, we access one or more paid subscription services for receiving messages based on this topic, if already available or when they become available. In step 760, we select from the amassed materials, personalize and organize them. Selection in step 760 may be based on priorities resulting from source, date, degree of relevance, payment (e.g. advertising revenue or cost), language, or other suitable parameter. Personalization may include language translation, insertion of further supplementary materials such as images, or data related to a particular student. Materials may then be organized based on the selection criteria, or on other useful criteria (e.g., length of material, currency of material, reading level, or other relevant criteria) and an indication of the materials presented back to the user in step 350 of FIG. 3.

FIGS. 8a and 8b illustrate some of the parameters that may be used to identify the user and to personalize the conditioned content using the present invention. A first user profile is provided as FIG. 8a and illustrates a user or recipient that has a reading or comprehension level of the third grade and interested in geographic aspects of the topic (for instance, because the teacher is preparing a handout sheet based on a current even noted). The selection of supplemental material (in text form) then would have to be consistent with the reading comprehension abilities of a third-grader to comprehend and the content would be consistent with geographic aspects. A second user profile is provided in FIG. 8b where the audience has the reading comprehension level of a college student who is looking for audiovisual materials such as a film clip and values political aspects of the news, perhaps because this is being prepared by a political science professor as an audio visual presentation for his course. In the case of the profile of FIG. 8b, audio materials could be used along with text and video materials, then reading level should be consistent with college level abilities and the emphasis might be on recent political activities in a country like Korea (the type of government, the leaders and their background, the type of government, etc.) rather than on the geography which was provided for the profile of FIG. 8a.

Thus, FIG. 8a depicts a personalized preferences profile in which the intended user has a reading or comprehension level of third grade (at entry 811), is interested in geography (shown by entry 812), wants text entries (in entry 813) in English language (line 814) ad all selected components should be met for inclusion of content (entry 820).

Similarly, FIG. 8b depicts a personalized profile in which the intended user is reading or comprehension level at a college level (entry 821), is particularly interested in political content (entry 822) in any content form (which would include audio/visual material as well as content without audio or video) (at entry 823) in the English language (entry 828) and the content selected should be the best possible fit for the requirements (at entry 830). The “best fit” means that the content does not have to meet all of the items listed in the personalized profile but should be a relatively good fit as compared with the items listed in the personalized profile, as one can imagine sets of items or requirements that are difficult, if not impossible, to meet completely, but meeting most of the most of the requirement would be sufficient (as compared to the example of FIG. 8a where the objective is to meet all of the requirements or items in the personalized profile, as indicated by the specification of all in the entry 820 for the profile of FIG. 8a and best fit in the entry 830 for the profile of FIG. 8b).

The type of content in an article may be determined by the content itself as well as other indexing information such as metadata. The reading level can be determined from the vocabulary used (where each word has a grade level associated with it and the highest grade level of the majority of the vocabulary words determines the grade level, along with the length of the sentences, where the longer the sentence and the more complex the sentence is with additional clauses and complex verbs such as subjunctives can be used to determine the reading level of a piece of text).

The identification of user preferences may also indicate the amount of material to be provided. In some cases, the entire supplementary material may be included, but in other cases, only a topic sentence, topic paragraph or relevant section will be desired.

Further, the preferences could also indicate a preferred language for the supplemental materials. This identification of a language which is understandable by the intended user, could either be used to determine which material is selected or, if a translation engine is available, the language into which the supplemental materials are to be translated. It should be noted that many useful pieces of information are available in the Russian or Japanese languages but they are of little use unless the user is proficient in the Russian or Japanese languages, respectively, unless they are translated into a useful language through a translation engine or the equivalent text is found in the user's language.

Further, the user preferences may include any number of parameters which can be combined in any suitable logical format. For example, the user preferences might be two parameters which are both required (an “AND” function that the content meets both criteria). The user preferences might be a longer list where the “best fit” of content which best meets most of the specified parameters would be selected. The parameters also might be expressed in the negative, that a particular kind of content is not desired or that a particular reading level must not be exceeded or the content must not be less than a certain level (to avoid boring the audience with trite materials or materials on an irrelevant subject).

One can see from the foregoing description that supplemental content might be quite different depending on the preferences file for a particular user and that the same base content might generate radically different conditioned content depending on the parameters specified for a particular user. Of course, the content might be quite different if one user wants a text output and another user wants audiovisual content, with this variation alone meaning that the first user gets only text and the second user may get supplemental audio and multimedia material as well as supplemental text material for his base material. A base article on John Philip Sousa might include some historical information for a “text only” user, while the user whose preference includes audiovisual material may see videos of recorded parades with the performance of Sousa's material as the accompanying audio, as well as sound clips from performances of some of his arrangements.

It will also be apparent to one skilled in the relevant art that certain features of the Hot Link Creator Patent could be used to advantage in the present system. For example, that patent includes a concept of displaying candidates located through a search for inclusion in the conditioned content and allowing a user to select (or not select) one of the candidates (or even a portion of a candidate) for inclusion. The present invention can exploit the features of the Hot Link Creator Patent, particularly for presenting URLs or web links that emerge as part of the selected supplementary material to augment and condition the base material.

It will also be seen that some of the items in the preferences file may be met by suitable use of tools or personal skills. For example, if relevant material is available in a language other than that which is specified, it may be translated, either manually or by a suitable translation tool such as the commercially-available software program known as Trados software, which is in use generally today. This Trados software generates a repository of previously translated material, such as sentences, and can prompt a human with the previously translated material for confirmation or changes. Similarly, there are tools which can determine the comprehension level of a piece of material based on sentence length and structure as well as the verbal content of the material. If the material matching the requirements is at too high a reading comprehension level, such material may be converted to a lower comprehension level but changing the sentence structure (e.g., by shortening the sentences and removing clauses) and using simpler vocabulary, either through the use of a software tool or through the use of a person or some combination of the two (for example, where software suggests a change and the person either confirms the change or rejects it).

The list of preferences may also include preferences as to the age of the materials, for example, preferring the newest materials possible or materials from a particular vintage. If the user is interested in how opinions or presentations have changed over time, one could specify an early period and a later period and compare the supplement content for the same base content. This difference in conditioned content might provide the user with insight as to the effects of intervening events such as an election or a war.

The preferences file may be stored at a convenient place, such as on a requester's personal computer and transmitted at the time of a request. It is also possible for a user to have more than one preferences file and to select the preferences file to be used for a particular content conditioning exercise. This would be understood for a teacher who teaches different subjects or different levels of comprehension, that is, for a teacher who teaches ninth grade social studies and twelfth grade American government to have different user preferences for each of these two assignments.

A history file of past content conditioning for a particular user would also allow for the user to specify that he wanted only material which had not been used for content conditioning before. In that way a user could determine whether there was new content for a piece of base material and not duplicate past content conditioning exercises.

Although illustrative embodiments and methods of the preferred embodiment of the present invention have been described herein with some particularity with reference to the accompanying drawings, it is to be understood that the invention is not limited to those precise embodiments, and that various other changes and modifications may be made by one skilled in the art without departing from the scope or spirit of the invention. For example, the rules engine and text analysis engine might be replaced with another suitable method for identifying the terms to be conditioned. Further, some of the elements described in connection with the preferred embodiment may be useful without the corresponding use of other elements that have been discussed herein. The format of any preference file might be tailored for each user or a single profile or preference file might apply to a class of users, and the profile might be stored in the user's system or in a central system. Further, the profile might have only a single variable (such as reading level) or a series of parameters, which parameters may be selectively combined in any Boolean or logical fashion (with some parameters being more specified as more important or weighted more heavily than others, if desired) and may be used in a best fit arrangement or in a fit that requires all of the parameters to be present (third grade level and in English). Also, some of the parameters might be expressed in the negative (articles not previously included or content which is not political or materials dated not earlier than 2004). Accordingly, the foregoing description should be considered as merely illustrative of the principles of the present invention and not in limitation thereof, as the scope of the present invention is defined by the claims which follow and any equivalents which would be apparent to those skilled in the relevant art.

1. A method of creating personalized content using content conditioning from base content comprising the steps of:
analyzing the base content to determine words and phrases which are candidates for conditioning;
consulting a stored preferences file including personalization preferences to determine what additional conditioning content to select;
selecting additional conditioning content from a database based on the candidates for conditions determined from base content and the personalization preferences from the preferences file; and
forming a conditioned content output including the base content and the selected additional conditioning content based on the database, the base content, and the personalization preferences contained in the preferences file.

2. A method of creating personalized content using content conditioned from base content as set forth in claim 1 further including the step of using local databases and the Internet.

3. A method of creating personalized content using content conditioned from base content as set forth in claim 1 further including the step of using a set of personalization preferences which include at least one of the comprehension level of the audience and a preferred language of the audience.

4. A method of creating personalized content using content conditioned from base content as set forth in claim 1 where the step of analyzing the base content includes at least one of the steps of determining keywords, analyzing images to recognize text within the images and performing natural language analysis.

5. A method of creating personalized content using content conditioned from base content as set forth in claim 1 further including the step of using a personalization preference which includes the format of material which is suitable for inclusion, where the format includes categories of text, audio, visual and audio-visual materials.

6. A method of creating personalized content using content conditioned from base content as set forth in claim 1 further including the step of selecting supplemental content for conditioning is based on a date of the supplemental content, said date comprising at least one of a date of content creation, a date of content acquisition, a date of content publication.

7. A method of creating personalized content using content conditioned from base content as set forth in claim 1 further including the step of selecting supplemental content based on whether such content has been previously used for that user.

8. A method of creating personalized content using content conditioned from base content as set forth in claim 1 further including the step of selecting supplemental content based on all of the user preferences being met.

9. A method of creating personalized content using content conditioned from base content as set forth in claim 1 further including the step of selecting supplemental content based on a best fit to the user preferences.

10. A system for creating personalized conditioned content based on base content, the system comprising:
an analysis engine which operates on the base content to determine candidates for content conditioning;
logic which uses rules to select the topics for conditioning based on a preference file;
communications which access one or more data repositories to locate content based on the candidates for content conditioning and the selected topics for conditioning; and
an editor which combines the base content with selected supplemental content from the data repositories based on the preference file to create a content conditioned output.

11. A system for personalizing content based on base content, the system further comprising a search tool for performing a Google search over the Internet as well as a search of other web resources.

12. A system for creating personalized conditioned content based on base content, the system of the type described in claim 11 further comprising a tool for searching a private database as well as public databases accessible over the Internet.

13. A system for creating personalized conditioned content based on base content, the system of the type described in claim 10 further comprising a system for determining the desired comprehension level of the supplemental content and for determining the comprehension level of potential supplemental material.

14. A system for creating personalized conditioned content based on base content, the system of the type described in claim 13 further comprising means for determining that supplemental material is not of the desired comprehension level and for converting the material to the desired comprehension level.

15. A system for creating personalized conditioned content based on base content, the system of the type described in claim 10 further comprising identifying a desired language for the supplemental material and comparing the desired language with the language of supplemental material which has been identified.

16. A system for creating personalized conditioned content based on base content, the system of the type described in claim 10 further including a system for identifying material which has been previously provided to that user for that base material and for providing different supplemental material.

17. A system for creating personalized conditioned content based on base content, the system of the type described in claim 10 further including a system for recognizing the type of match which is desired and providing supplementary material based on the type of match which is desired.

18. A system of claim 17 where the desired match for the material is a “best fit” match and the system includes logic which determines the supplementary material which is the best match to the preferences file.

19. A system for creating personalized conditioned content based on base content, the system of the type described in claim 10 further including a system for determining supplemental content which matches identified time parameters.

20. A program stored on a tangible medium for creating conditioned content comprising:
a first module for receiving base content and determining the candidates for conditioning;
a second module for receiving a preferences file;
a third module for determining supplemental content which is relevant to the base content and meets the preferences of the preferences file; and
a fourth module which takes the supplemental content and combines it with the base content to form conditioned content.

21. A stored program including the modules of claim 20 and further including a module for determining the best fit of supplemental content with the requirements of the preferences file.

22. A stored program for creating conditioned content including the modules of claim 20 wherein the third module for determining supplemental content accesses a Google search on the Internet, another search of the public Internet and a search of a private database.

23. A stored program for creating conditioned content including the modules of claim 20 wherein the program further includes a module to determine the comprehension level of the content and compare it to the desired comprehension level in the preferences file.

24. A stored program including the modules of claim 23 wherein the program further includes a module for converting the comprehension level of the material to a desired comprehension level.

25. A stored program for creating conditioned content including the modules of claim 20 wherein the program further includes a module for determining the language of supplemental material and for comparing the language to a language stored in the preferences file.

26. A stored program for creating conditioned content including the modules of claim 25 wherein the program further includes a translation tool for converting supplementary material from a language other than the language specified in the preferences file to a language specified in the preferences file.
